(19) United States
(12) Patent Application Publication
(10) Pub. No.: US 2026/0244750 A1
(43) Pub. Date: Aug. 20, 2026

(54) PROVIDING FLEXIBILITY FOR SAFE AND SECURE OTA PACKAGE UPDATE IN MULTI-ECU AUTO SYSTEMS

(71) Applicant: QUALCOMM Incorporated, San Diego, CA (US)

(72) Inventors: Ananda Kishore PARASA, Hyderabad (IN); Yashavantha RAO, Hyderabad (IN); Shyam MAHESHWARI, Hyderabad (IN); Santosh Pavan Kumar DRONAMRAJU, Hyderabad (IN)

(21) Appl. No.: 19/059,120

(22) Filed: Feb. 20, 2025

(51) Int. Cl. G06F 21/57; G06F 8/65

(52) U.S. Cl. CPC G06F 21/572; G06F 8/65; G06F 2221/033

(57) ABSTRACT

Aspects presented herein may enable an electronic control unit (ECU) with a higher capability to authenticate the over-the-air (OTA) package for an ECU with a lower capability to improve the overall performance of OTA update. In one aspect, a vehicle receives, from a server, a plurality of individual ECU OTA update packages for a plurality of ECUs of the vehicle. The vehicle identifies a set of ECUs in the plurality of ECUs that are unable to perform authentication for their corresponding individual ECU OTA update packages. The vehicle authenticates the corresponding individual ECU OTA update packages for the set of ECUs using at least one other ECU, where the at least one other ECU has a trust level or a capability greater than or equal to the set of ECUs. The vehicle enables the set of ECUs to apply their corresponding individual ECU OTA update packages if authentication is successful.

### TECHNICAL FIELD

The present disclosure relates generally to assisted/autonomous driving, and more particularly, to the over-the-air (OTA) package update associated with multiple electronic control units (ECUs) systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a server, a plurality of individual electronic control unit (ECU) over-the-air (OTA) update packages for a plurality of ECUs of the vehicle. The apparatus identifies a set of ECUs in the plurality of ECUs that are unable to perform authentication for their corresponding individual ECU OTA update packages. The apparatus authenticates the corresponding individual ECU OTA update packages for the set of ECUs using at least one other ECU, where the at least one other ECU has a trust level or a capability greater than or equal to the set of ECUs. The apparatus enables the set of ECUs to apply their corresponding individual ECU OTA update packages if authentication is successful.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a vehicle performing road object detection using different types of sensors in accordance with various aspects of the present disclosure.

FIG. 5 is a diagram illustrating an example of a vehicle performing an over-the-air (OTA) update in accordance with various aspects of the present disclosure.

FIG. 6 is a diagram illustrating an example of a multi-stage/multi-phase authentication in accordance with various aspects of the present disclosure.

FIG. 7 is a flowchart illustrating an example process of a multi-stage/multi-phase authentication in accordance with various aspects of the present disclosure.

FIG. 8 is a diagram illustrating an example of using one electronic control unit (ECU) to authenticate OTA package for one or more ECUs in accordance with various aspects of the present disclosure.

FIG. 9 is a flowchart illustrating an example process of using one ECU to authenticate OTA package for one or more ECUs in accordance with various aspects of the present disclosure.

FIG. 10 is a diagram illustrating an example of ECU groups in accordance with various aspects of the present disclosure.

FIG. 11 is a flowchart of a method of drive scene topology estimation.

FIG. 12 is a flowchart of a method of drive scene topology estimation.

FIG. 13 is a diagram illustrating an example of a hardware implementation for an example apparatus and/or network entity.

### DETAILED DESCRIPTION

Aspects presented herein may improve the overall performance of over-the-air (OTA) package update by providing a flexibility for safe and secure OTA package update in multi-electronic control unit (multi-ECU) vehicle systems. Aspects presented herein may enable electronic control units (ECUs) to be grouped according to their trust levels (which may include the security levels and/or the safety levels), such that a larger ECU (referring to an ECU with a higher capability) in a group may authenticate the update package for a smaller ECU (referring to an ECU with a lower capability), where the smaller ECU may not have the capability to handle a complex authentication or have the flexibility to have an OTA agent. Then, after the authentication, the ownership may be returned to the smaller ECU which may continue with writing of its OTA package (e.g., into its corresponding swap partition using some secure channel, ensuring the new images are updated via OTA during the next boot).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

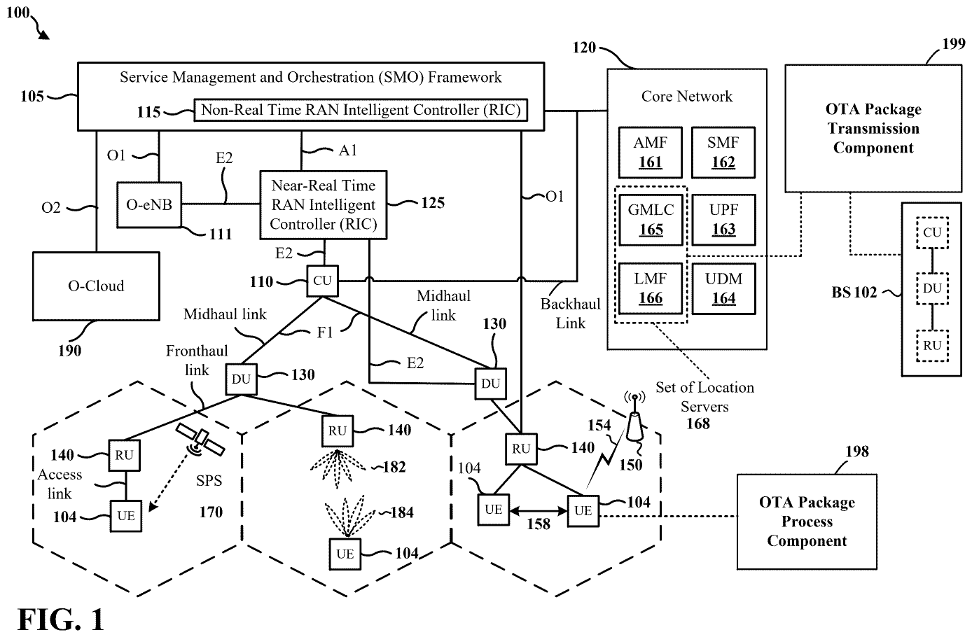

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an OTA package process component 198 that may be configured to receive, from a server, a plurality of individual electronic control unit (ECU) over-the-air (OTA) update packages for a plurality of ECUs of the vehicle; identify a set of ECUs in the plurality of ECUs that are unable to perform authentication for their corresponding individual ECU OTA update packages; authenticate the corresponding individual ECU OTA update packages for the set of ECUs using at least one other ECU, where the at least one other ECU has a trust level or a capability greater than or equal to the set of ECUs; and enable the set of ECUs to apply their corresponding individual ECU OTA update packages if authentication is successful. In certain aspects, the base station 102 or the one or more location servers 168 may have an OTA package transmission component 199 that may be configured to provide OTA update package to the UE 104.

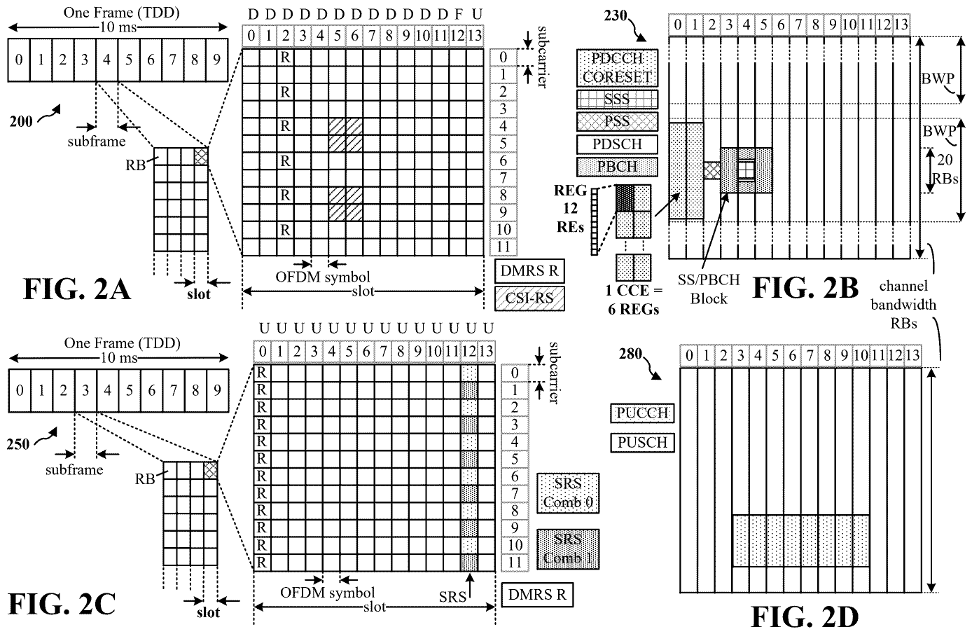

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

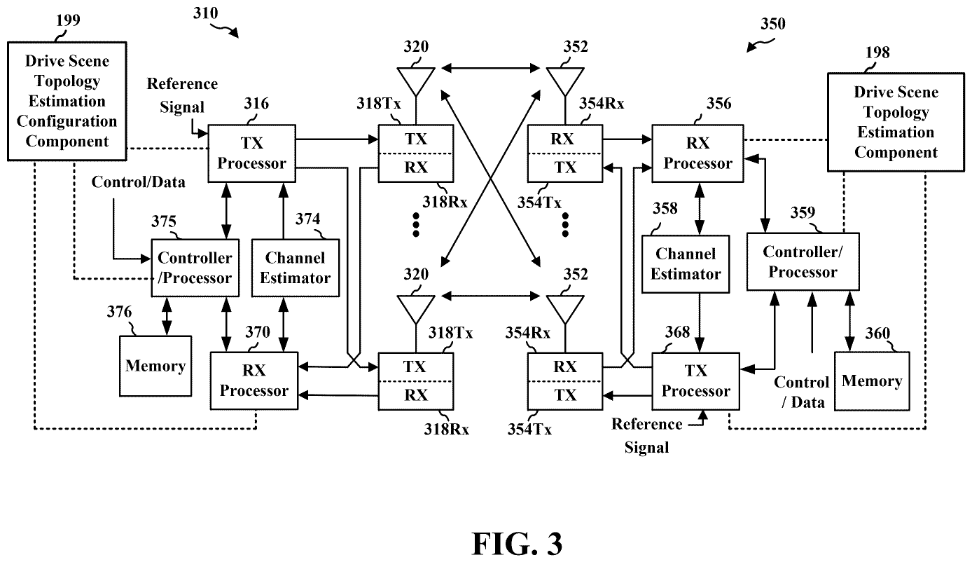

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the OTA package process component 198 of FIG. 1.

At least one of the TX processor 316, the RX processor 370, and the controller/processor 375 may be configured to perform aspects in connection with the OTA package transmission component 19p of FIG. 1.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), radar(s), light detection and ranging (lidar(s) or lidar sensor(s)), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving (AD), which may also be referred to as the autonomous driving system (ADS), self-driving, and/or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc.

Note while some assisted/autonomous driving systems may demand the use of HD map data, there are also assisted/autonomous driving systems and information systems that may be configured not to use HD map data (e.g., due to costs). For example, the Society of Automotive Engineers (SAE) has defined six levels of driving automation, from Level 0 (no automation) to Level 5 (full automation). For Level 0 (no automation), the human driver may be responsible for all aspects of driving, and the system may provide warnings or momentary assistance but does not take control of the vehicle. Example features for SAE Level 0 may include automatic emergency braking, blind spot warnings, and lane departure warnings, etc. As such, SAE Level 0 may not specify using HD map data. For Level 1 (driver assistance), the vehicle may assist with either steering or acceleration/deceleration (but may not perform both simultaneously). The human driver is still responsible for most driving tasks and may need to be ready to take over at any time. Example features for SAE Level 1 may include adaptive cruise control or lane-keeping assistance (e.g., lane centering), etc. For Level 2 (partial automation), the vehicle may control both steering and acceleration/deceleration under certain conditions, but the human driver is requested to remain engaged and monitor the driving environment at all times. Example features for SAE Level 2 may include ADAS, adaptive cruise control and lane-keeping assistance at the same time, etc. For Level 3 (conditional automation), the vehicle may perform all driving tasks under specific conditions, and the human driver may not be specified to monitor the environment but may need to be ready to take over when requested by the system. Example features for SAE Level 3 may include traffic jam chauffeur, where the vehicle is capable of handling driving in traffic jams without driver intervention. For Level 4 (high automation), the vehicle is capable of handling all driving tasks within certain conditions or environments (geofenced areas). The system may operate without human intervention but may specify a human driver outside its operational domain. Example features for SAE Level 4 may include local driverless taxi and pedals/steering, etc. For Level 5 (full automation), the vehicle is capable of performing all driving tasks under all conditions, and does not specify the human driver at any time. Example features for SAE Level 5 may include fully autonomous vehicles with no steering wheel or pedals. In summary, SAE Level 0 may be defined as features to provide warnings and assistance. ADAS is usually SAE Level 1 and 2, while AD is considered SAE level 3 to 5.

To enable a vehicle to be capable of providing assisted driving and/or autonomous driving, the vehicle may be configured to use various machine learning (ML) and/or neural network (NN) frameworks. An ML/NN framework may refer to a set of tools, libraries, and/or software components that are configured to provide a structured way to design, build, and deploy ML/NN models and applications. These frameworks may be able to simplify the process of developing ML/NN algorithms and applications by providing a foundation of pre-built functions, algorithms, and utilities. They may typically include features for data preprocessing, model training, evaluation, and/or deployment, etc. ML/NN frameworks may come in various programming languages, and they may be configured to cater to different types of machine learning tasks, including supervised learning, unsupervised learning, and/or reinforcement learning, etc. An ML/NN model may refer to a mathematical representation of a real-world process or problem, created using ML/NN algorithms and techniques. These ML/NN models may be configured to make predictions, classify data, and/or solve specific tasks based on patterns and relationships learned from input data. A deep learning framework may refer to a specialized software library or toolset that provides specified components and abstractions for building, training, and deploying deep neural networks. Deep learning frameworks may be designed to facilitate the development of complex neural network models, especially deep neural networks with multiple layers. These frameworks may offer a wide range of pre-implemented layers, optimizers, loss functions, and other components, making it easier for researchers and developers to work with deep learning models.

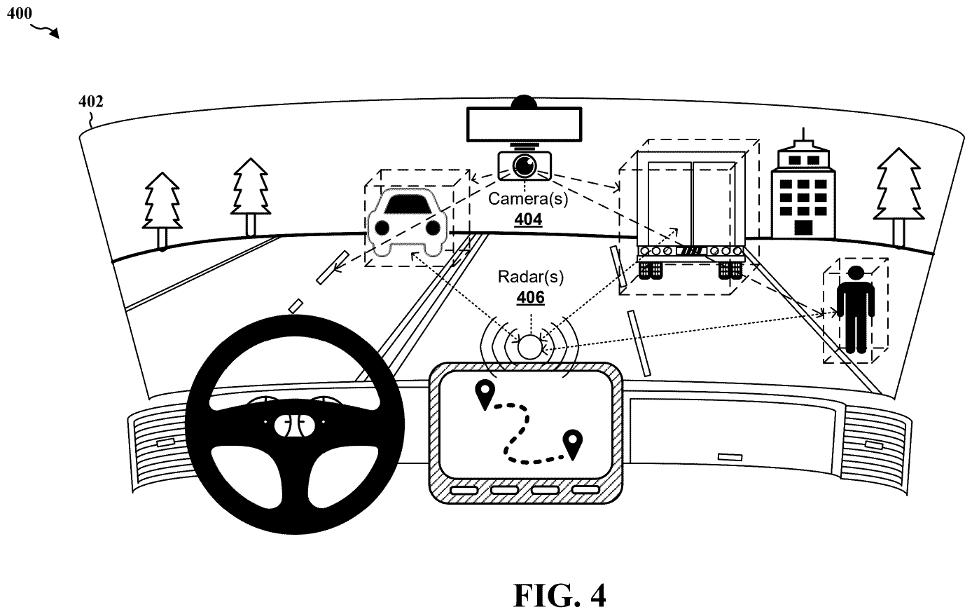

FIG. 4 is a diagram 400 illustrating an example of a vehicle performing road object detection using different types of sensors in accordance with various aspects of the present disclosure. In some implementations, a vehicle system may be configured to perform road object detections using multiple types of sensors (and also one or more ML/NN models). For purposes of the present disclosure, a road object or a traffic participant may refer to an object that is related to roads and driving, and is typically/commonly used/considered by the vehicle system in providing assisted driving or performing autonomous driving. In some examples, the road object/traffic participant may also be referred to as a “traffic object” or a “traffic-related object.” For example, a road object/traffic participant may be another vehicle, a pedestrian, a cyclist/bicycle, an animal, a traffic cone, a traffic sign, a traffic light, traffic, a traffic lane, a traffic line, a vulnerable road user (VRU), an object that is within a threshold distance of the vehicle, and/or any objects that may typically present on the roads (e.g., on the driving paths of vehicles), etc. On the other hand, a non-road object or a non-traffic participant (which may also be referred to as a non-traffic related object) may refer to an object that is not related to roads and driving, and is typically/commonly not used/considered by the vehicle system in providing assisted driving or performing autonomous driving. For example, a non-road object/non-traffic participant may be an object that is not within a threshold distance of the vehicle (e.g., a house on the side of the road, a mountain that is far away), an object that is not typically presented on a driving path/road (an airplane, a fire hydrant, a tree, etc.), a structure that is typically not traversed by vehicles (e.g., a pedestrian bridge), etc. An ML/NN model may be trained to identify whether an object is a road object or a non-road object.

For example, as shown by the diagram 400, a vehicle or a vehicle system (collectively as a “UE 402”) may be configured to use different types of sensors, such as a set of cameras 404 and/or a set of radars 406 for detecting road objects. For purposes of the present disclosure, the term “radar” may broadly refer to a device/component that is capable of detecting at least the presence and/or the distance of a physical object. Examples of radar may include an RF radar, a sonar, an ultrasonic sensor, a light detection and ranging (lidar), etc. In some implementations, the UE 402 may also use different MN/NN models for identifying different types of road objects. For example, a first ML/NN model may be trained/used to detect and track polylines from sensor output(s) (e.g., images captured by the camera(s) of the vehicle, point clouds generated from radar(s)/lidar(s), etc.), while a second ML/NN model may be trained/used to detect and track objects in a three-dimensional (3D) space (e.g., to perform 3D object detection (3DOD) tasks). Then, the outputs of different types of sensors (e.g., from the set of cameras 404 and the set of radars 406) may be processed and used by the ADAS or the autonomous driving system (e.g., for assisted/autonomous driving). A point cloud may refer to a discrete set of data points in space, where these points may represent a 3D shape or object. In some implementations, each point position may be associated with a set of Cartesian coordinates (X, Y, Z). Point clouds may be produced by radar(s)/lidar(s) by detecting multiple points on the external surfaces of objects.

For purposes of the present disclosure and in the context of assisted/autonomous driving, a vehicle that is capable of performing autonomous driving and/or certain amount of assisted driving may be referred to as an “ego vehicle” or simply “ego.” For example, an “ego lane” may refer to a lane in which an ego vehicle itself is currently driving. As such, the term “ego” in such context may refer to the vehicle itself, and the term “ego lane” may imply that it is the lane where the (ego) vehicle is actively maneuvering and making decisions. Depending on the context, the term “ego lane” may be used for differentiating the lane occupied by the ego/autonomous vehicle from other lanes on the road.

Various vehicle applications and systems (e.g., autonomous/assisted driving related applications and systems, auto electronic control unit (ECU) systems, etc.) may be specified/configured to be updated at least once in a while, periodically, and/or upon request. To perform the update, these applications and systems may be configured to download updated data/package from a server wirelessly from time to time or based on certain pre-defined conditions (e.g., when an update is available, when an error/bug it to be patched, etc.). In some implementations, downloading data/package from a server wirelessly may be referred to as “over-the-air” (OTA) download, and updating an application/system based on the OTA download may be referred to as the OTA update, OTA application/system update, and/or OTA data/package update, etc. Similarly, a firmware-over-the-air (FOTA) update may refer to the remote updating or upgrading of a vehicle's firmware.

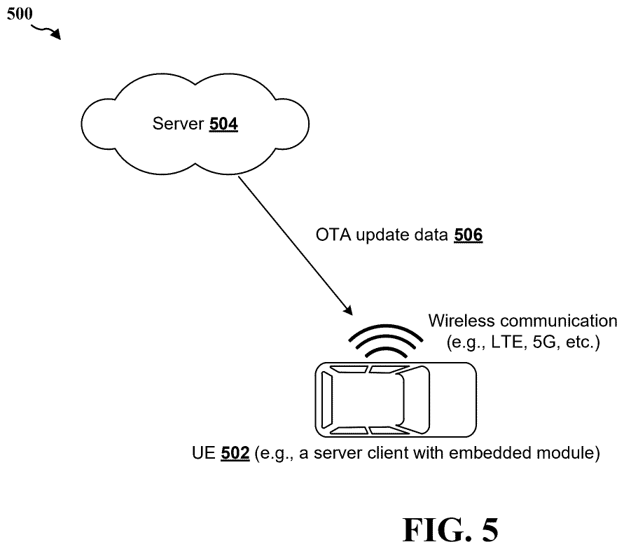

FIG. 5 is a diagram 500 illustrating an example of a vehicle performing an OTA update in accordance with various aspects of the present disclosure. In one example, an OTA update may refer to a process of a server 504 sending OTA update data 506 to a UE 502 (e.g., a vehicle, an on-board unit (OBU) of the vehicle, an ADAS of the vehicle, a device running a navigation application, etc.) over a wireless network (e.g., an LTE network, a 5G network, etc.), enabling the UE 502 to update various applications and systems (e.g., firmware) on the vehicle. For example, in a typical implementation, the OTA update data 506 is transmitted from the server 504 (e.g., a cloud-based system) to the UE 502 when the UE 502 has the capability to receive the OTA update data 506 (e.g., when there is available bandwidth to download the OTA update data 506). After the UE 502 downloaded the OTA update data 506, the UE 502 may be configured to perform the corresponding update using the OTA update data 506 when the UE 502 has the capability or is safe to do so (e.g., while the vehicle is not running or is offline, and/or when the update does not impact the performance/functions of the vehicle). For example, the UE 502 may receive an OTA update for an ECU of the vehicle while the vehicle is operating. After downloaded the OTA update for the ECU, the UE 502 may apply the OTA update to the ECU after the ignition of the vehicle is off (and also the vehicle has sufficient power to perform the OTA update).

In some scenarios, a typical vehicle system OTA package may be configured to include multiple individual ECU OTA packages. For example, the OTA update data 506 may include a plurality of OTA updates for a plurality of ECUs (or ECU subsystems/applications). If there is an issue with one of these individual ECU OTA packages (e.g., one of the individual ECU OTA packages is corrupted/faulty), the OTA update data 506 (i.e., the entire system OTA package) may be configured to be reversed, which may be costly for the vehicle (e.g., with respect to the wireless, processing, and/or time resources, etc.).

In some implementations, to prevent late detection of faulty OTA package(s) during upgrades (e.g., during FOTA engine upgrades), a vehicle may be configured to apply a multi-stage and/or multi-phase authentication (e.g., this may be mandatory for some vehicle OTA updates). One challenge with this approach is that each ECU may demand or may be specified to have an OTA agent for the authentication before the corresponding OTA package is writing into the swap partition (which may also be referred to as the “swap region”), from where the corresponding ECU picks the firmware image after the OTA. This may be difficult for smaller ECUs (referring to ECUs with lower capabilities), where every byte may be important, making smaller ECUs challenging to include an OTA agent. In other words, some smaller ECUs may not have sufficient memory and/or processing capability/resource to include an OTA agent. For purposes of the present disclosure (and in the context of vehicle OTA update), an OTA agent may refer to a firmware or software component or module embedded in a vehicle's system that facilitates the remote updating of its firmware/software. This capability may enable automotive manufacturers to send updates and patches directly to vehicles without specifying them to be physically brought into a service center, such as discussed in connection with FIG. 5. Depending on implementations, an OTA agent may be configured/designed to manage the secure download, verification, and installation of OTA updates, ensuring that the vehicle is able to receive improvements or fixes conveniently and efficiently. On the other hand, it is also not desirable/suitable to compromise the safety and/or security of ECU(s)/firmware by allowing/configuring a lower trust level ECU authenticating a higher trust level ECU OTA package.

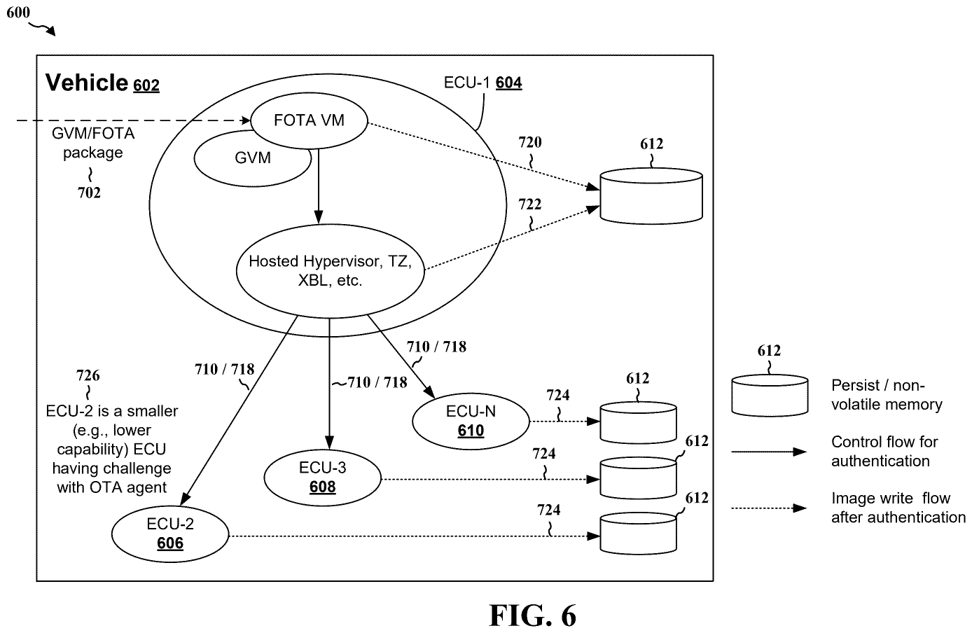

FIG. 6 is a diagram 600 illustrating an example of a multi-stage/multi-phase authentication in accordance with various aspects of the present disclosure. As discussed above, an ECU (electronic control unit) may refer to a component in a vehicle that functions as a small embedded computer designed to control one or more of the vehicle's systems or subsystems. Depending on implementations, the vehicle may have a plurality of ECUs that are configured for different functionalities and have different capabilities (e.g., different amount of memories and/or processing powers, etc.). As such, the plurality of ECUs may be integral to the vehicle's operation, where they may be configured to manage various functions ranging from engine performance to safety features.

As an illustration, a vehicle 602 may include a set of ECUs that is configured or responsible for various vehicle functions, where each ECU in the set of ECUs may have a different capability (e.g., different processing speed, different amount of memory resources, etc.). For example, the set of ECUs may include a first ECU 604 (ECU-1), a second ECU 606 (ECU-2), a third ECU 608 (ECU-3), and up to an N^{th} ECU 610 (ECU-N), etc. For purposes of illustration, assuming the first ECU 604 is a master ECU and the second ECU 606, the third ECU 608, and the N^{th} ECU 610 are sub ECUs. In this context, the master ECU and the sub ECU may refer to how different ECUs are organized and interact within a hierarchical system. This structure may typically be used to manage communication and control across multiple ECUs in a coordinated manner. In general, a master ECU may have a higher level control in accessing the resources like connectivity and memory, and may at the same time running at higher speeds compared to a sub ECU. There may also be different sub levels among sub ECUs. For example, a first group of sub ECUs may belong to a sub level 1 ECUs, and a second group of sub ECUs may belong to a sub level 2 ECUs, etc., where a sub level 1 ECUs may have a different trusted level, security level, and/or control level compared to a sub level 2 ECU.

As illustrated in details below, a multi-stage/multi-phase authentication may specify each ECU in the set of ECUs to authenticate its corresponding individual ECU OTA package before the ECU is able to write the corresponding individual ECU OTA package into its swap partition. In the context of ECU firmware updates, a swap partition or a swap region may refer to a reserved area of storage within the ECU's memory (e.g., a set of persist/non-volatile memories 612) that is used/configured to facilitate the update process. The swap partition may serve as a staging or temporary storage area for the new firmware before it is validated and activated, ensuring a secure and reliable update mechanism.

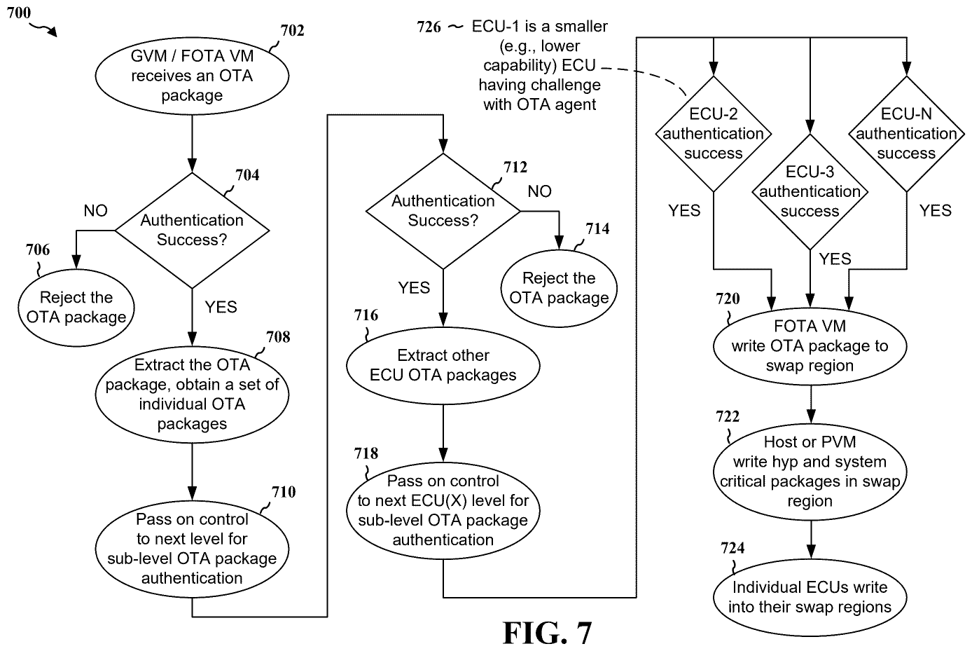

FIG. 7 is a flowchart 700 illustrating an example process of a multi-stage/multi-phase authentication in accordance with various aspects of the present disclosure. Aspects described herein may be illustrated in conjunction with FIG. 6.

As shown at 702, the first ECU 604 of the vehicle 602 (e.g., a master ECU, a main dashboard ECU, etc.) may receive a single OTA package from a server, such as described in connection with FIG. 5, where the OTA package may include a plurality of individual OTA update packages for the set of ECUs (or for one or more ECUs in the set of ECUs). For example, the OTA package may include a plurality of individual OTA update packages for the first ECU 604 (ECU-1), the second ECU 606 (ECU-2), the third ECU 608 (ECU-3), and the N^{th} ECU 610 (ECU-N)).

The first ECU 604 may include a generic virtual machine (GVM) and/or a firmware over-the-air virtual machine (FOTA VM) (collectively as “GVM/FOTA VM”) that is configured for receiving (and also applying) the OTA package. For purposes of the present disclosure, a GVM may typically act as an abstraction layer, providing a platform-independent environment to run software. In the automotive domain, a GVM may be used to enable compatibility between the vehicle's ECUs and the FOTA systems. A FOTA VM may refer to a specialized virtual machine (VM) that is dedicated to handling the FOTA process. This may include managing the downloading, verifying, and applying of firmware updates securely within a virtualized environment. In some examples, a GVM may be a feature rich VM and may include FOTA VM responsibilities in some scenarios to avoid a separate VM for FOTA purpose. Depending on implementations, the single OTA package may also be referred to as a GVM or FOTA VM package, and the plurality of individual OTA update packages may also be referred to as the plurality of individual OTA ECU update packages.

As shown at 704, after the first ECU 604 receives the OTA package (e.g., via the GVM/FOTA VM), the first ECU 604 may perform authentication for the OTA package, such as checking the integrity and/or authenticity of the OTA package. As shown at 706, if the authentication fails (e.g., does not pass), the first ECU 604 (or the vehicle 602) may reject the OTA package (which may prompt the vehicle 602 or the first ECU 604 to redownload the OTA package).

As shown at 708, if the authentication is successful (e.g., passes), the first ECU 604 may extract the OTA package to obtain the plurality of individual OTA update packages for the set of ECUs (e.g., for the second ECU 606, the third ECU 608, and the N^{th} ECU 610, etc.). At 710, the first ECU 604 may pass the control to next level (e.g., to sub ECU(s)) for sub-level OTA package authentication.

Depending on the number of ECUs levels, the vehicle 602 may be configured to repeat the steps above until each ECU with an individual OTA update package has authenticated its corresponding individual OTA update package. For example, assuming there are multiple sub levels among sub ECUs, where the second ECU 606 (ECU-2) is a sub level 1 ECU and the third ECU 608 (ECU-3) is a sub level 2 ECU. As such, the second ECU 606 (ECU-2) may have a higher trusted level, security level, and/or control level compared to the third ECU 608 (ECU-3).

At 712, the second ECU 606 may perform authentication for its individual OTA update package. As shown at 714, if the authentication fails, the second ECU 606 (or the vehicle 602) may reject the OTA package (which may prompt the vehicle 602 or the first ECU 604 to redownload the OTA package). Similarly, as shown at 716, if the authentication is successful, the second ECU 606 may extract other OTA packages in its corresponding individual OTA update package (if available). Assuming the individual OTA update package of the second ECU 606 includes the OTA update package for the third ECU 608, the second ECU 606 may extract this package. Then, at 718, the second ECU 606 may pass the control to next ECU(X) level for sub-level OTA package authentication, such as to the third ECU 608 which is a sub level 2 ECU.

As shown at 720, if the authentication performed by each ECU in the set of ECUs passes (e.g., the ECUs with individual OTA update packages such as the first ECU 604 to the N^{th} ECU 610), the FOTA VM may write the OTA package to a swap region. At 722, a process running on a hosted hypervisor or a process running on PVM may write the OTA packages in a swap region after the authentication is success (at the planned levels,) and also write system critical packages in a swap region. Then, at 724, individual ECUs may write their corresponding individual ECU OTA update packages into swap regions.

As discussed above, under this configuration, for an ECU to authenticate its corresponding (individual) OTA update package, the ECU may specify an OTA agent. In other words, each ECU may need an OTA agent for authentication before writing into its corresponding swap partition (i.e., a multi-stage authentication of ECU OTA packages is configured to prevent late detection of faulty packages during FOTA engine upgrades). However, this approach may be difficult for ECUs with lower capabilities. For example, as shown at 726, if the second ECU 606 is an ECU with a lower capability (e.g., with limited/low processing power and/or memory resources), the second ECU 606 may not be able to have an OTA agent. Thus, in some scenarios, the authentication may fail at the second ECU 606 (which may cause an error, cause the OTA package to be rejected, and/or cause an unintended OTA package to be applied), or the authentication may take a longer time (which may not be acceptable for certain vehicle functions).

Aspects presented herein may improve the overall performance of OTA package update by providing a flexibility for safe and secure OTA package update in multi-ECU vehicle systems. Aspects presented herein may enable ECUs to be grouped according to their trust levels (which may include the security levels and/or the safety levels), such that a larger ECU (referring to an ECU with a higher capability) in a group may authenticate the update package for a smaller ECU (referring to an ECU with a lower capability), where the smaller ECU may not have the capability to handle a complex authentication or have the flexibility to have an OTA agent. Then, after the authentication, the ownership may be returned to the smaller ECU which may continue with writing of its OTA package (e.g., into its corresponding swap partition using some secure channel, ensuring the new images are updated via OTA during the next boot).

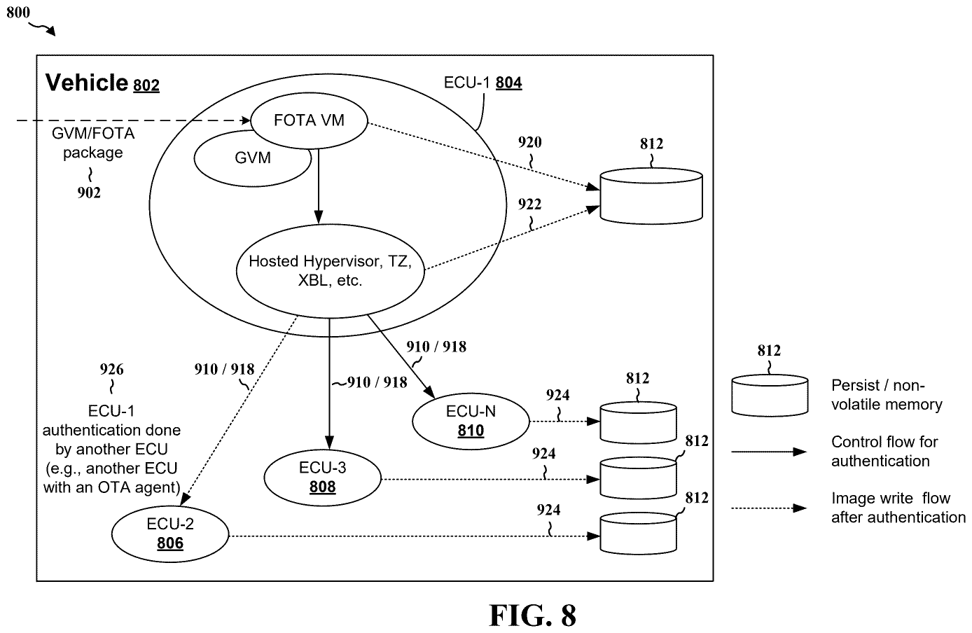

FIG. 8 is a diagram 800 illustrating an example of using one ECU (e.g., a larger ECU) to authenticate OTA package for one or more ECUs (e.g., smaller ECUs) in accordance with various aspects of the present disclosure. As discussed above, an ECU may refer to a component in a vehicle that functions as a small embedded computer designed to control one or more of the vehicle's systems or subsystems. Depending on implementations, the vehicle may have a plurality of ECUs that are configured for different functionalities and have different capabilities (e.g., different amount of memories and/or processing powers, etc.). As such, the plurality of ECUs may be integral to the vehicle's operation, where they may be configured to manage various functions ranging from engine performance to safety features.

As an illustration, a vehicle 802 may include a set of ECUs that is configured or responsible for various vehicle functions, where each ECU in the set of ECUs may have a different capability (e.g., different processing speed, different amount of memory resources, etc.). For example, the set of ECUs may include a first ECU 804 (ECU-1), a second ECU 806 (ECU-2), a third ECU 808 (ECU-3), and up to an N^{th} ECU 810 (ECU-N), etc. For purposes of illustration, assuming the first ECU 804 is a master ECU and the second ECU 806, the third ECU 808, and the N^{th} ECU 810 are sub ECUs. As discussed in connection with FIG. 6, the master ECU and the sub ECU may refer to how different ECUs are organized and interact within a hierarchical system, where a master ECU may have a higher level control in accessing the resources like connectivity and memory, and may at the same time running at higher speeds compared to a sub ECU. There may also be different sub levels among sub ECUs. For example, a first group of sub ECUs may belong to a sub level 1 ECUs, and a second group of sub ECUs may belong to a sub level 2 ECUs, etc., where a sub level 1 ECUs may have a different trusted level, security level, and/or control level compared to a sub level 2 ECU.

As illustrated in details below, the vehicle 802 may be configured to identify a set of ECUs (e.g., a set of smaller ECUs) that are unable to perform authentication for their corresponding individual ECU OTA update packages, and the vehicle 802 may enable at least one larger ECU to authenticate the corresponding individual ECU OTA update packages for the set of ECUs, where the at least one larger ECU has a trust level and/or a capability greater than or equal to the set of ECUs. Then, the vehicle 802 may enabling the set of ECUs to apply their corresponding individual ECU OTA update packages if authentication is successful. For example, after the at least one larger ECU authenticate the corresponding individual ECU OTA update packages for the set of ECUs, the at least one larger ECU may transfer the ownerships of the corresponding individual ECU OTA update packages to the set of ECUs to enable the set of ECUs to write their corresponding individual ECU OTA update packages into a swap partition (e.g., to a set of persist/non-volatile memories 812 using at least one secure channel).

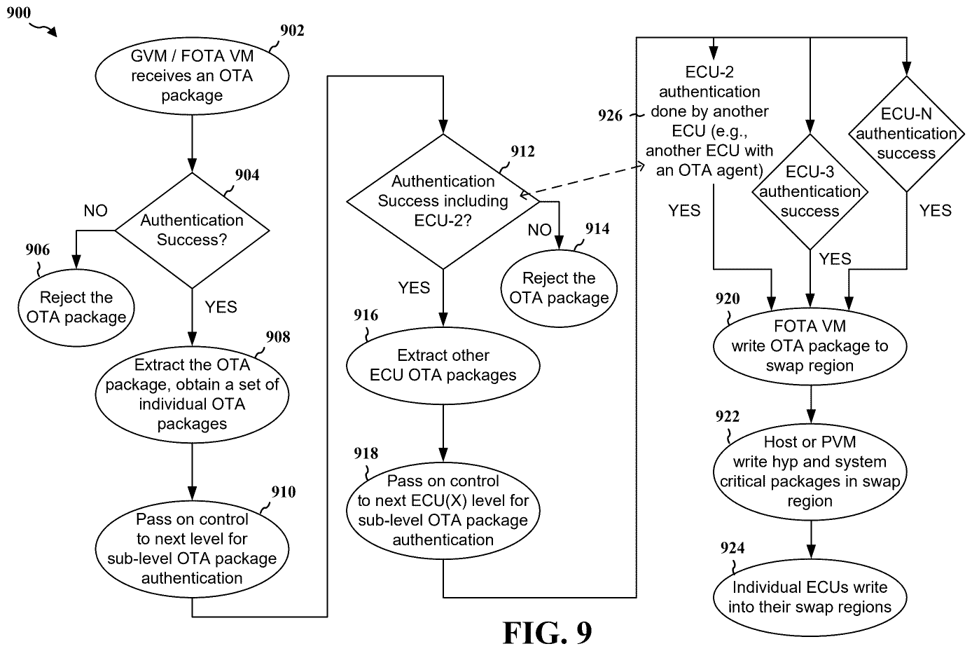

FIG. 9 is a flowchart 900 illustrating an example process of using one ECU (e.g., a larger ECU) to authenticate OTA package for one or more ECUs (e.g., smaller ECUs) in accordance with various aspects of the present disclosure. Aspects described herein may be illustrated in conjunction with FIG. 8.

As shown at 902, the first ECU 804 of the vehicle 802 (e.g., a master ECU, a main dashboard ECU, etc.) may receive a single OTA package from a server, such as described in connection with FIG. 5, where the OTA package may include a plurality of individual OTA update packages for the set of ECUs (or for one or more ECUs in the set of ECUs). For example, the OTA package may include a plurality of individual OTA update packages for the first ECU 804 (ECU-1), the second ECU 806 (ECU-2), the third ECU 808 (ECU-3), and the Ni ECU 810 (ECU-N).

The first ECU 804 may include a GVM/FOTA VM that is configured for receiving/processing the OTA package. As discussed, a GVM may act as an abstraction layer, providing a platform-independent environment to run software. In the automotive domain, a GVM may be used to enable compatibility between the vehicle's ECUs and the FOTA systems. Depending on implementations, the single OTA package may also be referred to as a GVM or FOTA VM package, and the plurality of individual OTA update packages may also be referred to as the plurality of individual OTA ECU update packages.

As shown at 904, after the first ECU 804 receives the OTA package (e.g., via the GVM/FOTA VM), the first ECU 804 may perform authentication for the OTA package, such as checking the integrity and/or authenticity of the OTA package. As shown at 906, if the authentication fails (e.g., does not pass), the first ECU 804 (or the vehicle 802) may reject the OTA package (which may prompt the vehicle 802 or the first ECU 804 to redownload the OTA package).

As shown at 908, if the authentication is successful (e.g., passes), the first ECU 804 may extract the OTA package to obtain the plurality of individual OTA update packages for the set of ECUs (e.g., for the second ECU 806, the third ECU 808, and the N^{th} ECU 810, etc.). At 910, the first ECU 804 may pass the control to next level (e.g., to sub ECU(s)) for sub-level OTA package authentication. Similarly, depending on the number of ECUs levels, the vehicle 802 may be configured to repeat the steps above until each ECU with an individual OTA update package has authenticated its corresponding individual OTA update package. For example, at 912, the second ECU 806 may perform authentication for its individual OTA update package. As shown at 914, if the authentication fails, the second ECU 806 (or the vehicle 802) may reject the OTA package. Similarly, as shown at 916, if the authentication is successful, the second ECU 806 may extract other OTA packages in its corresponding individual OTA update package (if available). Assuming the individual OTA update package of the second ECU 806 includes the OTA update package for the third ECU 808 (ECU-3), the second ECU 806 may extract this package. Then, at 918, the second ECU 806 may pass the control to next ECU(X) level for sub-level OTA package authentication, such as to the third ECU 808 (ECU-3) which is a sub level 2 ECU.

In one aspect of the present disclosure, as shown at 926, assuming the second ECU 806 (ECU-2) is a smaller ECU that is unable to (e.g., does not have capability to) perform authentication for its corresponding individual ECU OTA update package. For example, the vehicle 802 may identify/determine that the second ECU 806 is unable to perform its corresponding individual ECU OTA update package because the complexity for handling the authentication may exceed a complexity threshold and/or the second ECU 806 is unable to have an OTA agent.

Based on the identification that the second ECU 806 is a smaller ECU or does not have the capability to perform the authentication, the vehicle 802 may request/enable a larger ECU to handle the authentication of the second ECU 806's individual ECU OTA update package, where this larger ECU has a trust level (and capability) greater than or equal to the second ECU 806. For example, assuming the third ECU 808 is a larger ECU (and has an OTA agent), and also has a higher or the same trust level as the second ECU 806 (depending on implementations, the trust level may also include the security level and/or the safety level), at 910/912, the vehicle 802 may request/enable the third ECU 808 to handle the authentication of the second ECU 806's individual ECU OTA update package. In other words, the vehicle 802 may be configured to select at least one other ECU for authenticating the corresponding individual ECU OTA update packages for a set of smaller ECUs based on the trust level or the capability of the at least one other ECU.

As shown at 912, if the authentication of the second ECU 806's individual ECU OTA update package (e.g., performed by the third ECU 808) fails, the third ECU 808 (or the vehicle 802) may reject the OTA package. On the other hand, as shown at 916, if the authentication is successful, the third ECU 808 may extract other OTA packages in the corresponding individual OTA update package of the second ECU 806 (if available). Then, at 918, the third ECU 808 may pass the control to next ECU(X) level for sub-level OTA package authentication. In addition, the third ECU 808 may transfer ownership of the corresponding individual ECU OTA update package to the second ECU 806 (e.g., to enable the second ECU 806 to write the corresponding individual ECU OTA update package into a swap partition using at least one secure channel as discussed below).

As shown at 920, if the authentication performed by each ECU in the set of ECUs passes (i.e., including the authentication for the second ECU 806's individual ECU OTA update package performed by the third ECU 808), the FOTA VM may write the OTA package to a swap region (e.g., the set of persist/non-volatile memories 812). At 922, a process running on a hosted hypervisor or a process running on PVM may write the OTA packages in a swap region after the authentication is success (at the planned levels), and also write system critical packages in a swap region. Then, at 924, individual ECUs may write their corresponding individual ECU OTA update packages into swap regions.

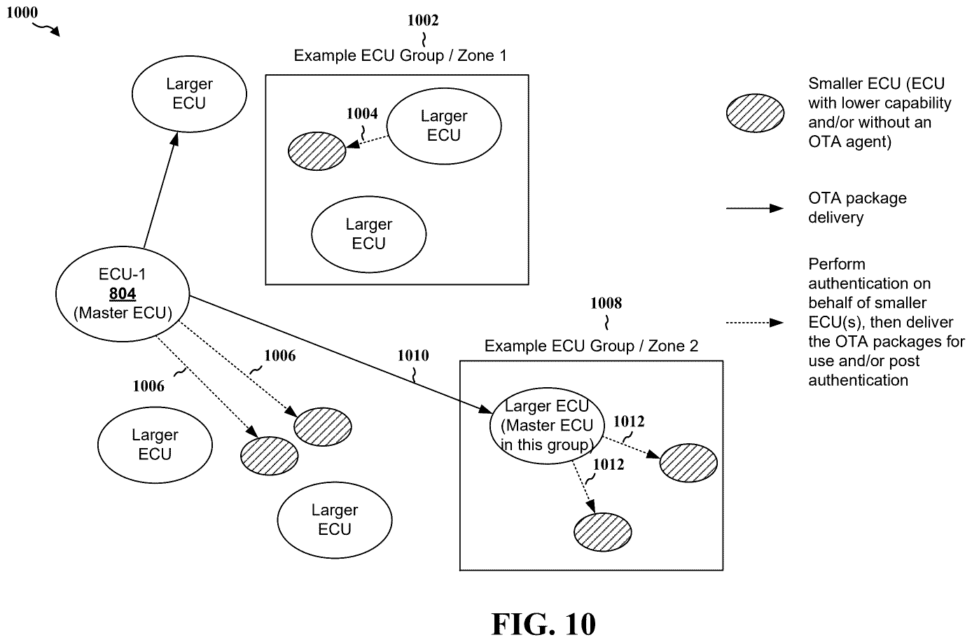

FIG. 10 is a diagram 1000 illustrating an example of ECU groups in accordance with various aspects of the present disclosure. In another aspect of the present disclosure, the vehicle 802 may be configured to group a plurality of ECUs based on their trust level, the capability, the safety level, and/or the functionality associated with the plurality of ECUs, etc. (e.g., to enable one ECU to authenticate OTA update package for another ECU(s)).

For example, as shown at 1002, the vehicle 802 may group multiple ECUs (e.g., two larger ECUs and one smaller ECU) together (e.g., based on their trust level, capability, safety level, zone, and/or functionality, etc.). Assuming this ECU group has two larger ECUs and a smaller ECU, where the smaller ECU does not have the capability to perform the authentication for its corresponding individual OTA update package. As shown at 1004, one of the larger ECU may be configured to perform the authentication for this smaller ECU, such as described in connection with 926 of FIG. 9. As shown at 1006, the first ECU 804 may also perform the authentication for smaller ECU(s) that does not belong to this group.

In another example, one ECU may also enable another ECU to perform authentication for other ECU(s). For example, as shown at 1008, the vehicle 802 may group multiple ECUs (e.g., one larger ECU and two smaller ECUs) together (e.g., based on their trust level, capability, safety level, zone, and/or functionality, etc.). As shown at 1010, the first ECU 804 may enable/assign the larger ECU in this group to be the “master ECU” in this group. Then, as shown at 1012, the larger ECU (the master ECU) in this group may perform the authentication for the corresponding individual OTA update packages of the two smaller ECUs (if the smaller ECUs do not have the capability to perform the authentication for their corresponding individual OTA update packages), such as described in connection with 926 of FIG. 9.

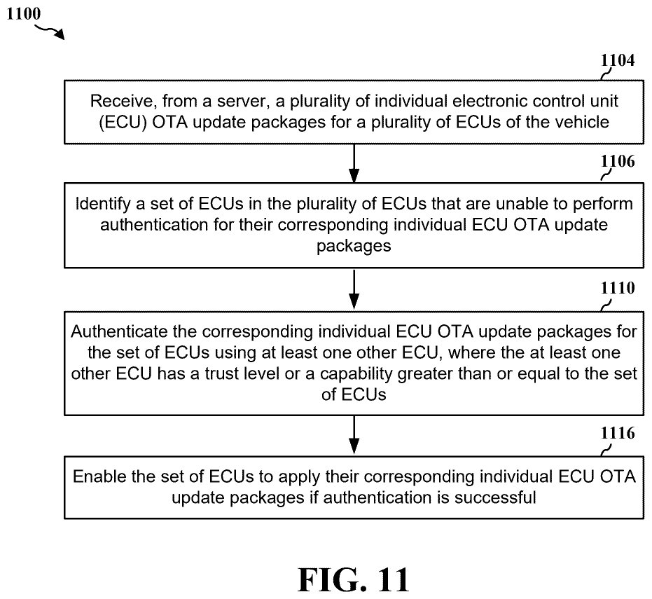

FIG. 11 is a flowchart 1100 of a method of OTA package update in a multi-ECU vehicle system. The method may be performed by a vehicle (e.g., the UE 104, 402, 502; the vehicle 602, 802; the apparatus 904). The method may enable the vehicle to group ECUs according to their trust levels (which may include the security levels and/or the safety levels), such that a larger ECU (referring to an ECU with a higher capability) in a group may authenticate the update package for a smaller ECU (referring to an ECU with a lower capability), where the smaller ECU may not have the capability to handle a complex authentication or have the flexibility to have an OTA agent.

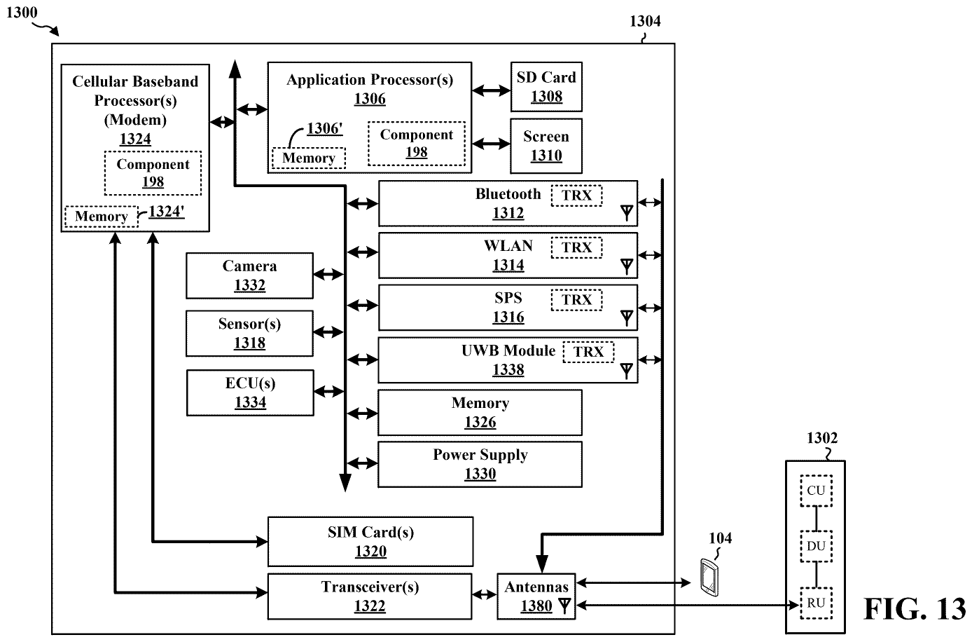

At 1104, the vehicle may receive, from a server, a plurality of individual ECU OTA update packages for a plurality of ECUs of the vehicle, such as described in connection with FIGS. 8 to 10. For example, as discussed in connection with 902 of FIG. 9, the first ECU 804 of the vehicle 802 (e.g., a master ECU, a main dashboard ECU, etc.) may receive a single OTA package from a server, such as described in connection with FIG. 5, where the OTA package may include a plurality of individual OTA update packages for the set of ECUs (or for one or more ECUs in the set of ECUs). The reception of the plurality of individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In one example, the plurality of ECUs are sub-ECUs and the at least one other ECU is a master ECU or one of the sub-ECUs.

In another example, to receive the plurality of individual ECU OTA update packages for the plurality of ECUs of the vehicle, the vehicle may be configured to receive the plurality of individual ECU OTA update packages for the plurality of ECUs of the vehicle in a single ECU OTA update package. In some implementations, the vehicle may further authenticate the single ECU OTA update package, and extract the single ECU OTA update package to obtain the plurality of individual ECU OTA update packages.

At 1106, the vehicle may identify a set of ECUs in the plurality of ECUs that are unable to perform authentication for their corresponding individual ECU OTA update packages, such as described in connection with FIGS. 8 to 10. For example, as discussed in connection with 926 of FIG. 9, the vehicle 802 may identify/determine that the second ECU 806 is unable to perform its corresponding individual ECU OTA update package because the complexity for handling the authentication may exceed a complexity threshold and/or the second ECU 806 is unable to have an OTA agent. The identification of the set of ECUs in the plurality of ECUs that are unable to perform authentication may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In one example, to identify the set of ECUs in the plurality of ECUs that are unable to perform authentication for their corresponding individual ECU OTA update packages, the vehicle may be configured to determine that the set of ECUs in the plurality of ECUs are unable to handle the authentication for their corresponding individual ECU OTA update packages based on at least one of: (1) a complexity for handling the authentication exceeds a complexity threshold, or (2) the set of ECUs does not have an OTA agent.

At 1110, the vehicle may authenticate the corresponding individual ECU OTA update packages for the set of ECUs using at least one other ECU, where the at least one other ECU has a trust level or a capability greater than or equal to the set of ECUs, such as described in connection with FIGS. 8 to 10. For example, as discussed in connection with 926 of FIG. 9, based on the identification that the second ECU 806 is a smaller ECU or does not have the capability to perform the authentication, the vehicle 802 may request/enable a larger ECU to handle the authentication of the second ECU 806's individual ECU OTA update package, where this larger ECU has a trust level (and capability) greater than or equal to the second ECU 806. The authentication of the corresponding individual ECU OTA update packages for the set of ECUs using at least one other ECU may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

At 1116, the vehicle may enable the set of ECUs to apply their corresponding individual ECU OTA update packages if authentication is successful, such as described in connection with FIGS. 8 to 10. For example, as discussed in connection with 920 of FIG. 9, if the authentication performed by each ECU in the set of ECUs passes (i.e., including the authentication for the second ECU 806's individual ECU OTA update package performed by the third ECU 808), the FOTA VM may write the OTA package to a swap region. At 922, a process running on a hosted hypervisor or a process running on PVM may write the OTA packages in a swap region after the authentication is success (at the planned levels), and also write system critical packages in a swap region. Then, at 924, individual ECUs may write their corresponding individual ECU OTA update packages into swap regions. The enablement of the set of ECUs to apply their corresponding individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In one example, to enable the set of ECUs to apply their corresponding individual ECU OTA update packages if the authentication is successful, the vehicle may be configured to transfer ownerships of the corresponding individual ECU OTA update packages to the set of ECUs after the authentication is successful to enable the set of ECUs to write their corresponding individual ECU OTA update packages into a swap partition using at least one secure channel.

In another example, the vehicle may select the at least one other ECU for authenticating the corresponding individual ECU OTA update packages for the set of ECUs based on the trust level or the capability of the at least one other ECU, such as described in connection with FIGS. 8 to 10. For example, as discussed in connection with 926 of FIG. 9, based on the identification that the second ECU 806 is a smaller ECU or does not have the capability to perform the authentication, the vehicle 802 may request/enable a larger ECU to handle the authentication of the second ECU 806's individual ECU OTA update package, where this larger ECU has a trust level (and capability) greater than or equal to the second ECU 806. The selection of the at least one other ECU for authenticating the corresponding individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In another example, the vehicle may enable a second set of ECUs in the plurality of ECUs to authenticate their corresponding individual ECU OTA update packages if they have capability to perform authentication for their corresponding individual ECU OTA update packages, such as described in connection with FIGS. 8 to 10. For example, as discussed in connection with 908 of FIG. 9, if the authentication is successful (e.g., passes), the first ECU 804 may extract the OTA package to obtain the plurality of individual OTA update packages for the set of ECUs (e.g., for the second ECU 806, the third ECU 808, and the Nth ECU 810, etc.). At 910, the first ECU 804 may pass the control to next level (e.g., to sub ECU(s)) for sub-level OTA package authentication. Similarly, depending on the number of ECUs levels, the vehicle 802 may be configured to repeat the steps above until each ECU with an individual OTA update package has authenticated its corresponding individual OTA update package. The enablement of the second set of ECUs in the plurality of ECUs to authenticate their corresponding individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In another example, the vehicle may group the plurality of ECUs based on at least one of the trust level, the capability, a safety level, or a functionality associated with the plurality of ECUs, such as described in connection with FIGS. 8 to 10. For example, as discussed in connection with 1002 of FIG. 10, the vehicle 802 may group multiple ECUs (e.g., two larger ECUs and one smaller ECU) together (e.g., based on their trust level, capability, safety level, zone, and/or functionality, etc.). The grouping of the plurality of ECUs may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In another example, the vehicle may reject the corresponding individual ECU OTA update packages for the set of ECUs if the authentication is not successful, such as described in connection with FIGS. 8 to 10. For example, as discussed in connection with 912 of FIG. 9, if the authentication of the second ECU 806's individual ECU OTA update package (e.g., performed by the third ECU 808) fails, the third ECU 808 (or the vehicle 802) may reject the OTA package. The rejection of the corresponding individual ECU OTA update packages for the set of ECUs may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

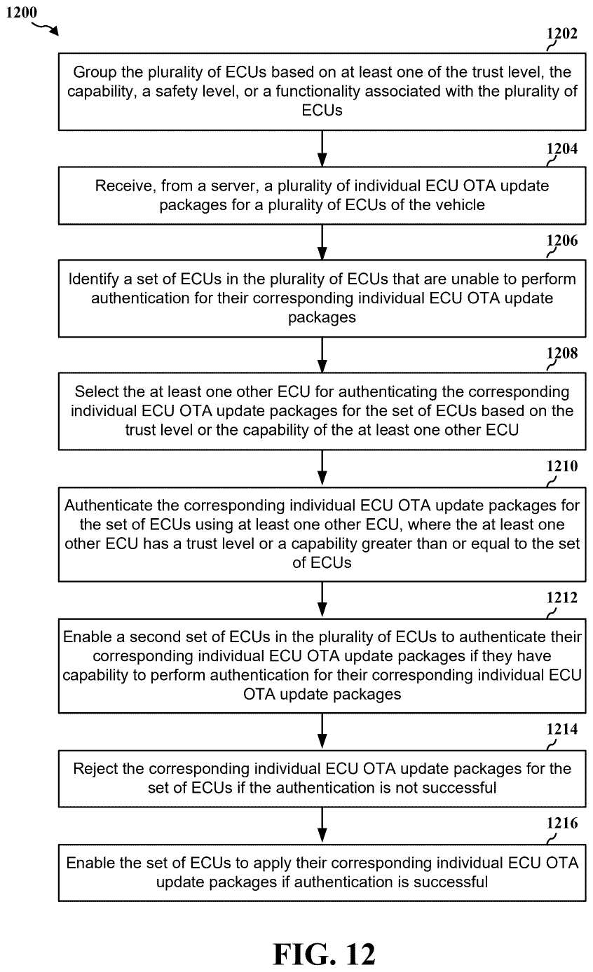

FIG. 12 is a flowchart 1200 of a method of OTA package update in a multi-ECU vehicle system. The method may be performed by a vehicle (e.g., the UE 104, 402, 502; the vehicle 602, 802; the apparatus 904). The method may enable the vehicle to group ECUs according to their trust levels (which may include the security levels and/or the safety levels), such that a larger ECU (referring to an ECU with a higher capability) in a group may authenticate the update package for a smaller ECU (referring to an ECU with a lower capability), where the smaller ECU may not have the capability to handle a complex authentication or have the flexibility to have an OTA agent.

At 1204, the vehicle may receive, from a server, a plurality of individual ECU OTA update packages for a plurality of ECUs of the vehicle, such as described in connection with FIGS. 8 to 10. For example, as discussed in connection with 902 of FIG. 9, the first ECU 804 of the vehicle 802 (e.g., a master ECU, a main dashboard ECU, etc.) may receive a single OTA package from a server, such as described in connection with FIG. 5, where the OTA package may include a plurality of individual OTA update packages for the set of ECUs (or for one or more ECUs in the set of ECUs). The reception of the plurality of individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In one example, the plurality of ECUs are sub-ECUs and the at least one other ECU is a master ECU or one of the sub-ECUs.

In another example, to receive the plurality of individual ECU OTA update packages for the plurality of ECUs of the vehicle, the vehicle may be configured to receive the plurality of individual ECU OTA update packages for the plurality of ECUs of the vehicle in a single ECU OTA update package. In some implementations, the vehicle may further authenticate the single ECU OTA update package, and extract the single ECU OTA update package to obtain the plurality of individual ECU OTA update packages.

At 1206, the vehicle may identify a set of ECUs in the plurality of ECUs that are unable to perform authentication for their corresponding individual ECU OTA update packages, such as described in connection with FIGS. 8 to 10. For example, as discussed in connection with 926 of FIG. 9, the vehicle 802 may identify/determine that the second ECU 806 is unable to perform its corresponding individual ECU OTA update package because the complexity for handling the authentication may exceed a complexity threshold and/or the second ECU 806 is unable to have an OTA agent. The identification of the set of ECUs in the plurality of ECUs that are unable to perform authentication may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In one example, to identify the set of ECUs in the plurality of ECUs that are unable to perform authentication for their corresponding individual ECU OTA update packages, the vehicle may be configured to determine that the set of ECUs in the plurality of ECUs are unable to handle the authentication for their corresponding individual ECU OTA update packages based on at least one of: (1) a complexity for handling the authentication exceeds a complexity threshold, or (2) the set of ECUs does not have an OTA agent.

At 1210, the vehicle may authenticate the corresponding individual ECU OTA update packages for the set of ECUs using at least one other ECU, where the at least one other ECU has a trust level or a capability greater than or equal to the set of ECUs, such as described in connection with FIGS. 8 to 10. For example, as discussed in connection with 926 of FIG. 9, based on the identification that the second ECU 806 is a smaller ECU or does not have the capability to perform the authentication, the vehicle 802 may request/enable a larger ECU to handle the authentication of the second ECU 806's individual ECU OTA update package, where this larger ECU has a trust level (and capability) greater than or equal to the second ECU 806. The authentication of the corresponding individual ECU OTA update packages for the set of ECUs using at least one other ECU may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

At 1216, the vehicle may enable the set of ECUs to apply their corresponding individual ECU OTA update packages if authentication is successful, such as described in connection with FIGS. 8 to 10. For example, as discussed in connection with 920 of FIG. 9, if the authentication performed by each ECU in the set of ECUs passes (i.e., including the authentication for the second ECU 806's individual ECU OTA update package performed by the third ECU 808), the FOTA VM may write the OTA package to a swap region. At 922, a process running on a hosted hypervisor or a process running on PVM may write the OTA packages in a swap region after the authentication is success (at the planned levels), and also write system critical packages in a swap region. Then, at 924, individual ECUs may write their corresponding individual ECU OTA update packages into swap regions. The enablement of the set of ECUs to apply their corresponding individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In one example, to enable the set of ECUs to apply their corresponding individual ECU OTA update packages if the authentication is successful, the vehicle may be configured to transfer ownerships of the corresponding individual ECU OTA update packages to the set of ECUs after the authentication is successful to enable the set of ECUs to write their corresponding individual ECU OTA update packages into a swap partition using at least one secure channel.

In another example, as shown at 1208, the vehicle may select the at least one other ECU for authenticating the corresponding individual ECU OTA update packages for the set of ECUs based on the trust level or the capability of the at least one other ECU, such as described in connection with FIGS. 8 to 10. For example, as discussed in connection with 926 of FIG. 9, based on the identification that the second ECU 806 is a smaller ECU or does not have the capability to perform the authentication, the vehicle 802 may request/enable a larger ECU to handle the authentication of the second ECU 806's individual ECU OTA update package, where this larger ECU has a trust level (and capability) greater than or equal to the second ECU 806. The selection of the at least one other ECU for authenticating the corresponding individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In another example, as shown at 1212, the vehicle may enable a second set of ECUs in the plurality of ECUs to authenticate their corresponding individual ECU OTA update packages if they have capability to perform authentication for their corresponding individual ECU OTA update packages, such as described in connection with FIGS. 8 to 10. For example, as discussed in connection with 908 of FIG. 9, if the authentication is successful (e.g., passes), the first ECU 804 may extract the OTA package to obtain the plurality of individual OTA update packages for the set of ECUs (e.g., for the second ECU 806, the third ECU 808, and the Nth ECU 810, etc.). At 910, the first ECU 804 may pass the control to next level (e.g., to sub ECU(s)) for sub-level OTA package authentication. Similarly, depending on the number of ECUs levels, the vehicle 802 may be configured to repeat the steps above until each ECU with an individual OTA update package has authenticated its corresponding individual OTA update package. The enablement of the second set of ECUs in the plurality of ECUs to authenticate their corresponding individual ECU OTA update packages may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In another example, as shown at 1202, the vehicle may group the plurality of ECUs based on at least one of the trust level, the capability, a safety level, or a functionality associated with the plurality of ECUs, such as described in connection with FIGS. 8 to 10. For example, as discussed in connection with 1002 of FIG. 10, the vehicle 802 may group multiple ECUs (e.g., two larger ECUs and one smaller ECU) together (e.g., based on their trust level, capability, safety level, zone, and/or functionality, etc.). The grouping of the plurality of ECUs may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

In another example, as shown at 1214, the vehicle may reject the corresponding individual ECU OTA update packages for the set of ECUs if the authentication is not successful, such as described in connection with FIGS. 8 to 10. For example, as discussed in connection with 912 of FIG. 9, if the authentication of the second ECU 806's individual ECU OTA update package (e.g., performed by the third ECU 808) fails, the third ECU 808 (or the vehicle 802) may reject the OTA package. The rejection of the corresponding individual ECU OTA update packages for the set of ECUs may be performed by, e.g., the OTA package process component 198, the one or more ECUs 1334, the transceiver(s) 1322, the cellular baseband processor(s) 1324, and/or the application processor(s) 1306 of the apparatus 1304 in FIG. 13.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an ultrawide band (UWB) module 1338, an SPS module 1316 (e.g., GNSS module), one or more sensors 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, a camera 1332, and/or one or more electronic control units (ECUs) 1334. The Bluetooth module 1312, the UWB module 1338, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the OTA package process component 198 may be configured to receive, from a server, a plurality of individual ECU OTA update packages for a plurality of ECUs of the vehicle. The OTA package process component 198 may also be configured to identify a set of ECUs in the plurality of ECUs that are unable to perform authentication for their corresponding individual ECU OTA update packages. The OTA package process component 198 may also be configured to authenticate the corresponding individual ECU OTA update packages for the set of ECUs using at least one other ECU, where the at least one other ECU has a trust level or a capability greater than or equal to the set of ECUs. The OTA package process component 198 may also be configured to enable the set of ECUs to apply their corresponding individual ECU OTA update packages if authentication is successful. The OTA package process component 198 may be within the cellular baseband processor(s) 1324, the application processor(s) 1306, or both the cellular baseband processor(s) 1324 and the application processor(s) 1306. The OTA package process component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, from a server, a plurality of individual ECU OTA update packages for a plurality of ECUs of the vehicle. The apparatus 1304 may further include means for identifying a set of ECUs in the plurality of ECUs that are unable to perform authentication for their corresponding individual ECU OTA update packages. The apparatus 1304 may further include means for authenticating the corresponding individual ECU OTA update packages for the set of ECUs using at least one other ECU, where the at least one other ECU has a trust level or a capability greater than or equal to the set of ECUs. The apparatus 1304 may further include means for enabling the set of ECUs to apply their corresponding individual ECU OTA update packages if authentication is successful.

In one configuration, the plurality of ECUs are sub-ECUs and the at least one other ECU is a master ECU or one of the sub-ECUs.

In another configuration, the means for receiving the plurality of individual ECU OTA update packages for the plurality of ECUs of the vehicle may include configuring the apparatus 1304 to receive the plurality of individual ECU OTA update packages for the plurality of ECUs of the vehicle in a single ECU OTA update package. In some implementations, the apparatus 1304 may further include means for authenticating the single ECU OTA update package, and means for extracting the single ECU OTA update package to obtain the plurality of individual ECU OTA update packages.

In another configuration, the means for identifying the set of ECUs in the plurality of ECUs that are unable to perform authentication for their corresponding individual ECU OTA update packages may include configuring the apparatus 1304 to determine that the set of ECUs in the plurality of ECUs are unable to handle the authentication for their corresponding individual ECU OTA update packages based on at least one of: (1) a complexity for handling the authentication exceeds a complexity threshold, or (2) the set of ECUs does not have an OTA agent.

In another configuration, the means for enabling the set of ECUs to apply their corresponding individual ECU OTA update packages if the authentication is successful may include configuring the apparatus 1304 to transfer ownerships of the corresponding individual ECU OTA update packages to the set of ECUs after the authentication is successful to enable the set of ECUs to write their corresponding individual ECU OTA update packages into a swap partition using at least one secure channel.

In another configuration, the apparatus 1304 may further include means for selecting the at least one other ECU for authenticating the corresponding individual ECU OTA update packages for the set of ECUs based on the trust level or the capability of the at least one other ECU.

In another configuration, the apparatus 1304 may further include means for enabling a second set of ECUs in the plurality of ECUs to authenticate their corresponding individual ECU OTA update packages if they have capability to perform authentication for their corresponding individual ECU OTA update packages.

In another configuration, the apparatus 1304 may further include means for grouping the plurality of ECUs based on at least one of the trust level, the capability, a safety level, or a functionality associated with the plurality of ECUs.

In another configuration, the apparatus 1304 may further include means for rejecting the corresponding individual ECU OTA update packages for the set of ECUs if the authentication is not successful.

The means may be the OTA package process component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of OTA package update at a vehicle, comprising: receiving, from a server, a plurality of individual electronic control unit (ECU) over-the-air (OTA) update packages for a plurality of ECUs of the vehicle; identifying a set of ECUs in the plurality of ECUs that are unable to perform authentication for their corresponding individual ECU OTA update packages; authenticating the corresponding individual ECU OTA update packages for the set of ECUs using at least one other ECU, wherein the at least one other ECU has a trust level or a capability greater than or equal to the set of ECUs; and enabling the set of ECUs to apply their corresponding individual ECU OTA update packages if authentication is successful.

Aspect 2 is the method of aspect 1, wherein enabling the set of ECUs to apply their corresponding individual ECU OTA update packages if the authentication is successful comprises: transferring ownerships of the corresponding individual ECU OTA update packages to the set of ECUs after the authentication is successful to enable the set of ECUs to write their corresponding individual ECU OTA update packages into a swap partition using at least one secure channel.

Aspect 3 is the method of aspect 1 or aspect 2, wherein identifying the set of ECUs in the plurality of ECUs that are unable to perform authentication for their corresponding individual ECU OTA update packages comprises: determining that the set of ECUs in the plurality of ECUs are unable to handle the authentication for their corresponding individual ECU OTA update packages based on at least one of: (1) a complexity for handling the authentication exceeds a complexity threshold, or (2) the set of ECUs does not have an OTA agent.

Aspect 4 is the method of any of aspects 1 to 3, wherein the plurality of ECUs are sub-ECUs and the at least one other ECU is a master ECU or one of the sub-ECUs.

Aspect 5 is the method of any of aspects 1 to 4, further comprising: selecting the at least one other ECU for authenticating the corresponding individual ECU OTA update packages for the set of ECUs based on the trust level or the capability of the at least one other ECU.

Aspect 6 is the method of any of aspects 1 to 5, further comprising: enabling a second set of ECUs in the plurality of ECUs to authenticate their corresponding individual ECU OTA update packages if they have capability to perform authentication for their corresponding individual ECU OTA update packages.

Aspect 7 is the method of any of aspects 1 to 6, further comprising: grouping the plurality of ECUs based on at least one of the trust level, the capability, a safety level, or a functionality associated with the plurality of ECUs.

Aspect 8 is the method of any of aspects 1 to 7, further comprising: rejecting the corresponding individual ECU OTA update packages for the set of ECUs if the authentication is not successful.

Aspect 9 is the method of any of aspects 1 to 8, wherein receiving the plurality of individual ECU OTA update packages for the plurality of ECUs of the vehicle comprises: receiving the plurality of individual ECU OTA update packages for the plurality of ECUs of the vehicle in a single ECU OTA update package.

Aspect 10 is the method of any of aspects 1 to 9, further comprising: authenticating the single ECU OTA update package; and extracting the single ECU OTA update package to obtain the plurality of individual ECU OTA update packages.

Aspect 11 is an apparatus for OTA package update at a vehicle, including: at least one memory; and at least one processor coupled to the at least one memory and, based at least in part on information stored in the at least one memory, the at least one processor is configured to implement any of aspects 1 to 10.

Aspect 12 is the apparatus of aspect 11, further including at least one transceiver coupled to the at least one processor.

Aspect 13 is an apparatus for OTA package update at a vehicle, including means for implementing any of aspects 1 to 10.

Aspect 14 is a computer-readable medium (e.g., a non-transitory computer-readable medium) storing computer executable code, where the code when executed by a processor causes the processor to implement any of aspects 1 to 10.

What is claimed is:

1. An apparatus at a vehicle, comprising:
at least one memory; and
at least one processor coupled to the at least one memory, wherein the at least one processor is configured to:
receive, from a server, a plurality of individual electronic control unit (ECU) over-the-air (OTA) update packages for a plurality of ECUs of the vehicle;
identify a set of ECUs in the plurality of ECUs that are unable to perform authentication for their corresponding individual ECU OTA update packages;
authenticate the corresponding individual ECU OTA update packages for the set of ECUs using at least one other ECU, wherein the at least one other ECU has a trust level or a capability greater than or equal to the set of ECUs; and
enable the set of ECUs to apply their corresponding individual ECU OTA update packages if authentication is successful.

2. The apparatus of claim 1, wherein to enable the set of ECUs to apply their corresponding individual ECU OTA update packages if the authentication is successful, the at least one processor is configured to:
transfer ownerships of the corresponding individual ECU OTA update packages to the set of ECUs after the authentication is successful to enable the set of ECUs to write their corresponding individual ECU OTA update packages into a swap partition using at least one secure channel.

3. The apparatus of claim 1, wherein to identify the set of ECUs in the plurality of ECUs that are unable to perform the authentication for their corresponding individual ECU OTA update packages, the at least one processor is configured to:
determine that the set of ECUs in the plurality of ECUs are unable to handle the authentication for their corresponding individual ECU OTA update packages based on at least one of: (1) a complexity for handling the authentication exceeds a complexity threshold, or (2) the set of ECUs does not have an OTA agent.

4. The apparatus of claim 1, wherein the plurality of ECUs are sub-ECUs and the at least one other ECU is a master ECU or one of the sub-ECUs.

5. The apparatus of claim 1, wherein the at least one processor is further configured to:
select the at least one other ECU for authenticating the corresponding individual ECU OTA update packages for the set of ECUs based on the trust level or the capability of the at least one other ECU.

6. The apparatus of claim 1, wherein the at least one processor is further configured to:
enable a second set of ECUs in the plurality of ECUs to authenticate their corresponding individual ECU OTA update packages if they have capability to perform authentication for their corresponding individual ECU OTA update packages.

7. The apparatus of claim 1, wherein the at least one processor is further configured to:
group the plurality of ECUs based on at least one of the trust level, the capability, a safety level, or a functionality associated with the plurality of ECUs.

8. The apparatus of claim 1, wherein the at least one processor is further configured to:
reject the corresponding individual ECU OTA update packages for the set of ECUs if the authentication is not successful.

9. The apparatus of claim 1, wherein to receive the plurality of individual ECU OTA update packages for the plurality of ECUs of the vehicle, the at least one processor is configured to:
receive the plurality of individual ECU OTA update packages for the plurality of ECUs of the vehicle in a single ECU OTA update package.

10. The apparatus of claim 9, wherein the at least one processor is further configured to:
authenticate the single ECU OTA update package; and
extract the single ECU OTA update package to obtain the plurality of individual ECU OTA update packages.

11. A method at a vehicle, comprising:
receiving, from a server, a plurality of individual electronic control unit (ECU) over-the-air (OTA) update packages for a plurality of ECUs of the vehicle;
identifying a set of ECUs in the plurality of ECUs that are unable to perform authentication for their corresponding individual ECU OTA update packages;
authenticating the corresponding individual ECU OTA update packages for the set of ECUs using at least one other ECU, wherein the at least one other ECU has a trust level or a capability greater than or equal to the set of ECUs; and
enabling the set of ECUs to apply their corresponding individual ECU OTA update packages if authentication is successful.

12. The method of claim 11, wherein enabling the set of ECUs to apply their corresponding individual ECU OTA update packages if the authentication is successful comprises:
transferring ownerships of the corresponding individual ECU OTA update packages to the set of ECUs after the authentication is successful to enable the set of ECUs to write their corresponding individual ECU OTA update packages into a swap partition using at least one secure channel.

13. The method of claim 11, wherein identifying the set of ECUs in the plurality of ECUs that are unable to perform the authentication for their corresponding individual ECU OTA update packages comprises:
determining that the set of ECUs in the plurality of ECUs are unable to handle the authentication for their corresponding individual ECU OTA update packages based on at least one of: (1) a complexity for handling the authentication exceeds a complexity threshold, or (2) the set of ECUs does not have an OTA agent.

14. The method of claim 11, wherein the plurality of ECUs are sub-ECUs and the at least one other ECU is a master ECU or one of the sub-ECUs.

15. The method of claim 11, further comprising:
selecting the at least one other ECU for authenticating the corresponding individual ECU OTA update packages for the set of ECUs based on the trust level or the capability of the at least one other ECU.

16. The method of claim 11, further comprising:
enabling a second set of ECUs in the plurality of ECUs to authenticate their corresponding individual ECU OTA update packages if they have capability to perform authentication for their corresponding individual ECU OTA update packages.

17. The method of claim 11, further comprising:
grouping the plurality of ECUs based on at least one of the trust level, the capability, a safety level, or a functionality associated with the plurality of ECUs.

18. The method of claim 11, further comprising:
rejecting the corresponding individual ECU OTA update packages for the set of ECUs if the authentication is not successful.

19. The method of claim 11, wherein receiving the plurality of individual ECU OTA update packages for the plurality of ECUs of the vehicle comprises:
receiving the plurality of individual ECU OTA update packages for the plurality of ECUs of the vehicle in a single ECU OTA update package.

20. A computer-readable medium storing computer executable code at a vehicle, the code when executed by at least one processor causes the at least one processor to:
receive, from a server, a plurality of individual electronic control unit (ECU) over-the-air (OTA) update packages for a plurality of ECUs of the vehicle;
identify a set of ECUs in the plurality of ECUs that are unable to perform authentication for their corresponding individual ECU OTA update packages;
authenticate the corresponding individual ECU OTA update packages for the set of ECUs using at least one other ECU, wherein the at least one other ECU has a trust level or a capability greater than or equal to the set of ECUs; and
enable the set of ECUs to apply their corresponding individual ECU OTA update packages if authentication is successful.
